(19) United States
(12) Patent Application Publication
(10) Pub. No.: US 2026/0234046 A1
(43) Pub. Date: Aug. 13, 2026

(54) SCORING APPARATUS AND GLASS CUTTING APPARATUS INCLUDING THE SAME

(71) Applicant: CORNING INCORPORATED, CORNING, NY (US)

(72) Inventors: Dong-Hwa Baek, Gyeonggi-do (KR); Tae-hun Han, Chungcheongnam-do (KR); Jung-mo Yang, Chungcheongnam-do (KR); Taeyoung Yoon, Chungcheongnam-do (KR)

(21) Appl. No.: 19/153,463

(22) PCT Filed: Jan. 26, 2024
(86) PCT No.: PCT/US2024/013018

§ 371 Date: Aug. 4, 2025

(30) Foreign Application Priority Data
Feb. 6, 2023 (KR) 10-2023-0015824

(51) Int. Cl. C03B 33/02; C03B 23/023

(52) U.S. Cl. CPC C03B 33/0215; C03B 23/023

(57) ABSTRACT

Provided is a scoring apparatus for scoring a glass ribbon moving in a vertical direction, comprising: a first rail which is spaced apart from and faces a first surface of the glass ribbon, and crosses the glass ribbon in a direction inclined with respect to the vertical direction; a scoring wheel reciprocating along the first rail and comprising a first pivot and a tip; a second rail that is spaced apart from a second surface while facing the second surface and extends parallel to the first rail, the second surface being opposite to the first surface of the glass ribbon; a support wheel reciprocating along the second rail and comprising a second pivot and a roll pad; and a supporter located below the second rail and configured to reciprocate in the vertical direction, wherein the tip forms a score line on the first surface of the glass ribbon.

### CROSS-REFERENCE TO RELATED APPLICATIONS

This application claims the benefit of priority of Korean Patent Application Serial No. 10-2023-0015824 filed on Feb. 6, 2023, the content of which is relied upon and incorporated herein by reference in its entirety.

### BACKGROUND

### 1. Field

The present disclosure relates to a scoring apparatus, and more particularly, to a scoring apparatus having improved speed for producing glass sheets.

### 2. Description of the Related Art

A traveling anvil machine (TAM) is used to form a horizontal scoring line on a glass ribbon. The TAM moves in the same direction as the glass ribbon at a velocity matching the velocity of the glass ribbon. While moving in the same direction as the glass ribbon, a linear slide attached to the TAM moves in a direction in which the glass ribbon moves. When the TAM moves along with the glass ribbon, a scoring wheel adhered to the linear slide comes into contact with the glass ribbon, scores the glass ribbon, and forms a horizontal scoring line across the glass ribbon.

While scoring the glass ribbon, it is required to provide a reaction force against the operation of the scoring wheel. The scoring using the TAM includes complicated processes and the scoring wheel comes into contact with the surface of the glass ribbon in difficult ways. Therefore, a system that is less complex and also efficient for the glass ribbon is necessary.

### SUMMARY

One or more embodiments of the present disclosure provide a scoring apparatus having an improved speed for forming a glass sheet.

One or more embodiments of the present disclosure provide a glass cutting apparatus capable of efficiently transporting a glass sheet.

It will be appreciated by one of ordinary skill in the art that that the objectives and effects that could be achieved with the inventive concept are not limited to what has been particularly described above and other objectives of the inventive concept will be more clearly understood from the following detailed description.

Additional aspects will be set forth in part in the description which follows and, in part, will be apparent from the description, or may be learned by practice of the presented embodiments of the disclosure.

According to an embodiment of the present disclosure, a scoring apparatus which scores a glass ribbon moving in a vertical direction, includes: a first rail which is spaced apart from and faces a first surface of the glass ribbon, and crosses the glass ribbon in a direction inclined with respect to the vertical direction; a scoring wheel reciprocating along the first rail and comprising a first pivot and a tip; a second rail that is spaced apart from a second surface while facing the second surface and extends parallel to the first rail, the second surface being opposite to the first surface of the glass ribbon; a support wheel reciprocating along the second rail and comprising a second pivot and a roll pad; and a supporter located below the second rail and configured to reciprocate in the vertical direction, wherein the tip forms a score line on the first surface of the glass ribbon.

According to an embodiment of the present disclosure, a glass cutting apparatus which forms a glass sheet by cutting a glass ribbon moving in a vertical direction, includes: a first rail which is spaced apart from and faces a first surface of the glass ribbon, and crosses the glass ribbon in a direction inclined with respect to the vertical direction; a scoring wheel reciprocating along the first rail and forming a score line on the first surface of the glass ribbon; a supporter located below the first rail and configured to reciprocate in the vertical direction; and a bender located below the first rail and configured to reciprocate in the vertical direction, wherein the bender bends the glass ribbon in a direction perpendicular to the vertical direction at a position lower than the score line.

According to an embodiment of the present disclosure, a glass cutting apparatus which forms a glass sheet by cutting a glass ribbon moving in a vertical direction, includes: a first rail which is spaced apart from and faces a first surface of the glass ribbon, and crosses the glass ribbon in a direction inclined with respect to the vertical direction; a scoring wheel reciprocating along the first rail and comprising a tip and a first pivot configured to move the tip; a second rail that is spaced apart from a second surface while facing the second surface and extends parallel to the first rail, the second surface being opposite to the first surface of the glass ribbon; a support wheel reciprocating along the second rail and comprising a roll pad and a second pivot configured to move the roll pad; a supporter that is located under the second rail, is spaced apart from the second surface of the glass ribbon while facing the second surface, and is configured to reciprocate in the vertical direction; and a bender that is located under the second rail, is spaced apart from the first surface of the glass ribbon while facing the first surface, and is configured to reciprocate in the vertical direction while tracking the glass ribbon, wherein the tip forms a score line on the first surface of the glass ribbon, the bender is absorbed onto the glass ribbon under the score line and bends the glass ribbon in a direction from the first surface toward the second surface, and the supporter comes into contact with the glass ribbon above a point where the bender is in contact with the glass ribbon.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a front view schematically showing a scoring apparatus according to an embodiment of the present disclosure;

FIG. 2 is a plan view schematically showing the scoring apparatus of FIG. 1;

FIG. 3 is a side view schematically showing the scoring apparatus of FIG. 1;

FIGS. 4A to 4C are plan views showing that a scoring wheel and a support wheel of a scoring apparatus according to an embodiment of the present disclosure move;

FIG. 5 is a plan view showing motion of a scoring wheel and a support wheel of a scoring apparatus according to an embodiment of the present disclosure;

FIGS. 6A to 6C are front views sequentially showing processes of forming a score line by the scoring apparatus according to an embodiment of the present disclosure;

FIG. 7 is a front view schematically showing a scoring apparatus according to an embodiment of the present disclosure;

FIG. 8 is a side view schematically showing a scoring apparatus according to an embodiment of the present disclosure;

FIG. 9 is a plan view showing the scoring apparatus of FIG. 8 forming a score line;

FIG. 10 is a front view schematically showing a glass cutting apparatus according to an embodiment of the present disclosure;

FIG. 11 is a side view schematically showing a glass cutting apparatus according to an embodiment of the present disclosure;

FIGS. 12A to 12E are side views sequentially showing processes of forming a score line by the glass cutting apparatus according to an embodiment of the present disclosure; and

FIG. 13 is a side view schematically showing a glass cutting apparatus according to an embodiment of the present disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

As the embodiments allow for various changes and numerous embodiments, particular embodiments will be illustrated in the drawings and described in detail in the written description. However, this is not intended to limit the embodiments to a certain disclosure.

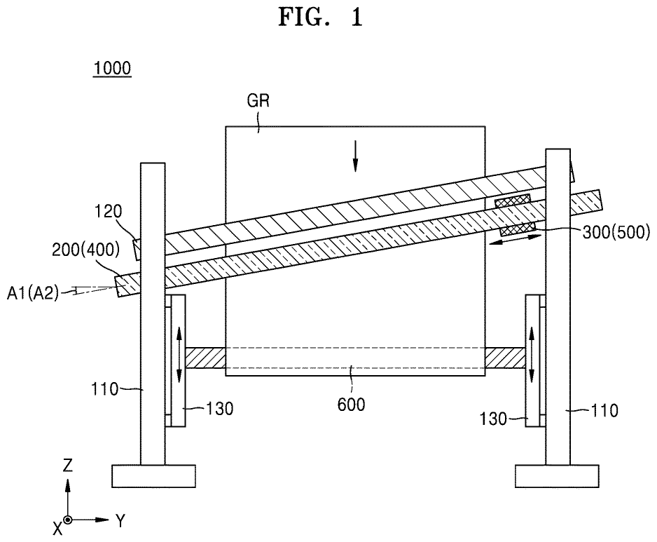

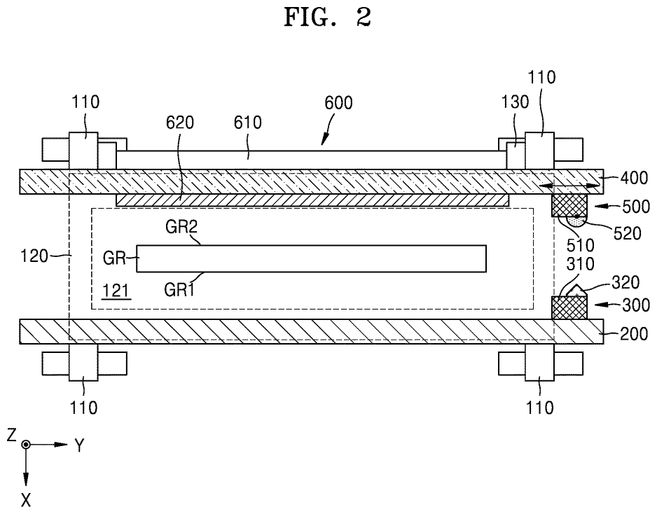

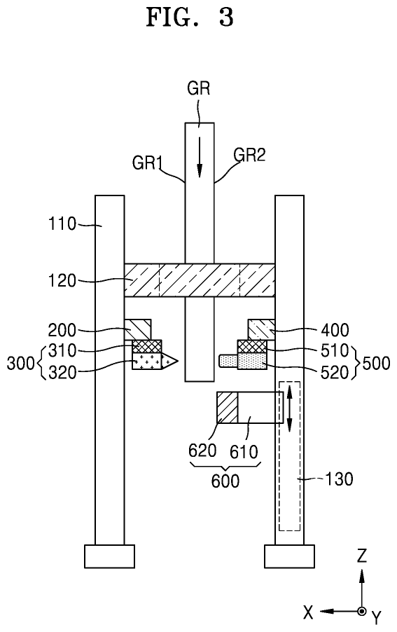

FIG. 1 is a front view schematically showing a scoring apparatus according to an embodiment of the present disclosure. FIG. 2 is a plan view schematically showing the scoring apparatus of FIG. 1. FIG. 3 is a side view schematically showing the scoring apparatus of FIG. 1.

In particular, FIG. 2 shows positional relationship among a glass ribbon GR, a first rail 200, and a second rail 400 by indicating a guide 120 in dashed lines when a scoring apparatus 1000 is seen on a plane. FIG. 3 shows a side view of the scoring apparatus with slopes of the first rail 200 and the second rail 400 omitted.

Referring to FIGS. 1 to 3, the scoring apparatus 1000 may include frames 110, the guide 120, the first rail 200, the second rail 400, a scoring wheel 300, a support wheel 500, and a supporter 600.

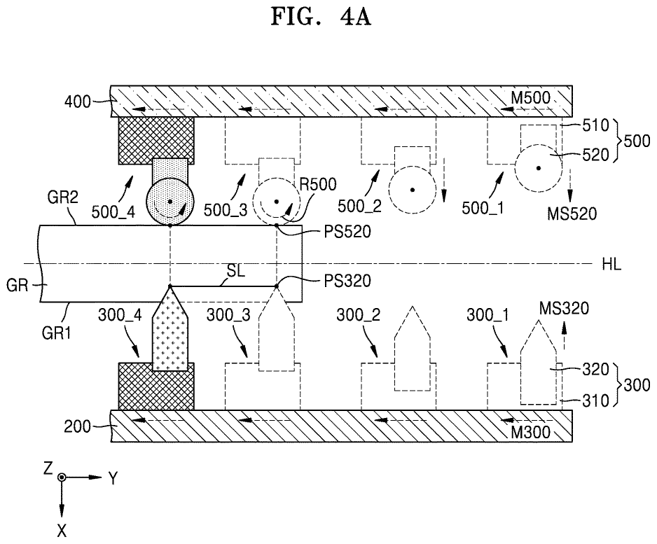

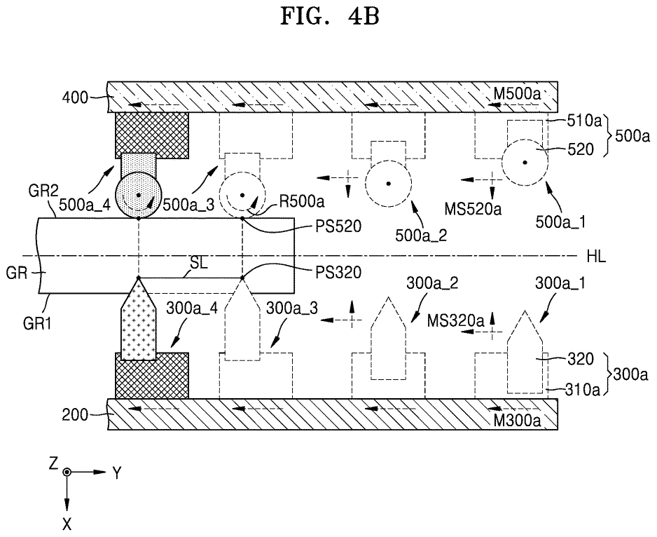

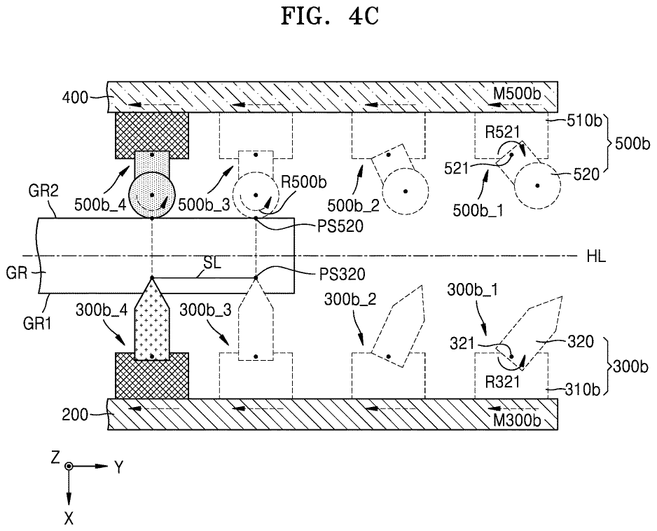

The scoring apparatus 1000 may score the glass ribbon GR that moves vertically. That is, the scoring apparatus 1000 may form a score line (SL of FIG. 4A) on one surface of the glass ribbon GR that moves vertically. A surface of the glass ribbon GR on which the score line is generated is referred to as a first surface GR1.

Hereinafter, the direction in which the glass ribbon GR vertically moves is a Z-axis direction. A direction that is perpendicular to the Z-axis direction and a thickness direction of the glass ribbon GR is referred to as an X-axis direction. A direction perpendicular to the Z-axis direction and the X-axis direction, that is, a width direction of the glass ribbon GR, is a Y-axis direction.

The frames 110 of the scoring apparatus 1000 may have the first rail 200, the second rail 400, and the supporter 600 attached thereto. In some embodiments, the frames 110 may extend in the Z-axis direction. The frames 110 may be located to be spaced in the X-axis direction and the Y-axis direction. In some embodiments, a spaced distance in the Y-axis direction may be greater than a spaced distance in the X-axis direction. The frames 110 may be installed on a ceiling or a ground of a working space.

The guide 120 of the scoring apparatus 1000 may be attached to the frames 110. The guide 120 may include a through-hole 121. The through-hole 121 may extend from an upper surface to a lower surface of the guide 120. The guide 120 may be located on the upper portions of the first rail 200 and the second rail 400.

In some embodiments, as shown in FIG. 2, the guide 120 may be formed in a rectangular parallelepiped shape including the through-hole 121. The glass ribbon GR may vertically move through the through-hole 121 of the guide 120. That is, the guide 120 may provide the glass ribbon GR with a moving passage.

The guide 120 may prevent course deviation of the glass ribbon GR against the vibration or shaking of the glass ribbon GR, which may occur during a moving process, a scoring process, and a cutting process.

The first rail 200 of the scoring apparatus 1000 may face the first surface GR1 of the glass ribbon GR. The first rail 200 may be spaced apart from the first surface GR1 of the glass ribbon GR. That is, the first rail 200 may not be in contact with the first surface GR1 of the glass ribbon GR. The first rail 200 may be spaced apart from one surface of the glass ribbon GR in the X-axis direction.

The first rail 200 may go across the glass ribbon GR in a direction inclined with respect to the vertical movement direction of the glass ribbon GR. In detail, the first rail 200 may extend across the glass ribbon GR in a direction inclined with respect to the Z-axis direction. In other words, the first rail 200 may extend in the direction inclined with respect to the Z-axis and the Y-axis. That is, the first rail 200 may be installed on the frame 110 to have an inclination when the scoring apparatus 1000 is seen from the front. In some embodiments, the first rail 200 may be installed on the frame 110 to be located lower than the guide 120 in the Z-axis direction.

In some embodiments, the first rail 200 may extend in a direction inclined with respect to the Y-axis direction. The first rail 200 and the Y-axis may cross each other at a first angle A1. That is, the first rail 200 may be inclined with respect to the Y-axis by the first angle A1. In some embodiments, the first angle A1 may be about 5° to about 20°. For example, the first angle A1 may be 7°.

The second rail 400 of the scoring apparatus 1000 may face a second surface GR2 of the glass ribbon GR, which is opposite to the first surface GR1 of the glass ribbon GR. The second rail 400 may be spaced apart from the second surface GR2. That is, the second rail 400 may be spaced apart from the second surface GR2 of the glass ribbon GR in the X-axis direction.

In other words, the second rail 400 may be spaced apart from the first rail 200 with the glass ribbon GR interposed therebetween. That is, the first rail 200 is located above the first surface GR1 of the glass ribbon GR, and the second rail 400 may be located above the second surface GR2 of the glass ribbon GR.

The second rail 400 may go across the glass ribbon GR in a direction inclined with respect to the vertical movement direction of the glass ribbon GR. In detail, the second rail 400 may extend across the glass ribbon GR in a direction inclined with respect to the Z-axis direction. In other words, the second rail 400 may extend in the direction inclined with respect to the Z-axis and the Y-axis. That is, the second rail 400 may be installed on the frame 110 to have an inclination when the scoring apparatus 1000 is seen from the front. In some embodiments, the second rail 400 may be installed on the frame 110 to be located lower than the guide 120 in the Z-axis direction.

The second rail 400 may extend parallel to the first rail 200. That is, the second rail 400 and the first rail 200 may extend parallel to each other. In other words, the first angle A1 and a second angle A2 may be equal to each other.

In some embodiments, the second rail 400 may extend in a direction inclined with respect to the Y-axis direction. The second rail 400 and the Y-axis may cross each other at the second angle A2. That is, the second rail 400 is inclined with respect to the Y-axis at the second angle A2. In some embodiments, the second angle A2 may be about 5° to about 20°. For example, the second angle A2 may be 7°.

The scoring wheel 300 of the scoring apparatus 1000 may reciprocate along the first rail 200. That is, the scoring wheel 300 may reciprocate on the first surface GR1 of the glass ribbon GR along the first rail 200. In some embodiments, the scoring wheel 300 may be moved along the first rail 200 via an actuator.

The scoring wheel 300 may include a first pivot 310 and a tip 320. The first pivot 310 turns the tip 320 so that the first surface GR1 of the glass ribbon GR may come into contact with or may be separated from the tip 320. The method for the first pivot 310 to turn the tip 320 will be described later.

The tip 320 may form a score line (SL of FIG. 4A) on the first surface GR1 by coming into contact with the first surface GR1 of the glass ribbon GR. That is, the tip 320 may form the score line on the glass ribbon GR by moving while penetrating the glass ribbon GR to at least a part. The tip 320 may move along the first rail 200 while actually coming into contact with the first surface GR1 of the glass ribbon GR to be perpendicular to the first surface GR1.

In some embodiments, the tip 320 may include at least one of polycrystalline diamond, carbide, and a glass cutting material.

The support wheel 500 of the scoring apparatus 1000 may reciprocate along the second rail 400. That is, the support wheel 500 may reciprocate above the second surface GR2 of the glass ribbon GR along the second rail 400. In some embodiments, the support wheel 500 may move along the second rail 400 via an actuator.

The support wheel 500 may include a second pivot 510 and a roll pad 520. The second pivot 510 turns the roll pad 520 so that the roll pad 520 may come into contact with or may be separated from the second surface GR2 of the glass ribbon GR. The method for the second pivot 510 to turn the roll pad 520 will be described later.

The roll pad 520 may come into contact with the second surface GR2 of the glass ribbon GR. In some embodiments, the roll pad 520 may formed in a roller that is in point-contact with the second surface GR2 of the glass ribbon GR. The roll pad 520 may move along the second rail 400 while coming into contact with the second surface GR2 of the glass ribbon GR. Accordingly, the roll pad 520 may come into contact with the second surface GR2 of the glass ribbon GR while moving along the score line.

A point where the tip 320 and the first surface GR1 contact each other and a point where the roll pad 520 and the second surface GR2 contact each other may face each other. In other words, the point where the tip 320 contacts the first surface GR1 and the point where the roll pad 520 contacts the second surface GR2 may be symmetrical with each other based on a horizontal line (HL of FIG. 4A) across the glass ribbon GR. While the tip 320 forms the score line, the roll pad 520 comes into contact with the glass ribbon GR at an opposite point to the point where the tip 320 comes into contact with the glass ribbon GR, and then, the roll pad 520 may provide the glass ribbon GR with the reaction force. That is, the roll pad 520 may support the glass ribbon GR when the tip 320 forms the score line.

The scoring wheel 300 and the support wheel 500 may form the score line (SL of FIG. 4A) on the first surface GR1 of the glass ribbon GR, while respectively moving along the first rail 200 and the second rail 400. Because the first rail 200 and the second rail 400 extend in the direction inclined with respect to the moving direction of the glass ribbon GR in parallel to each other, the scoring wheel 300 and the support wheel 500 may be moved parallel to each other in the direction inclined with respect to the moving direction of the glass ribbon GR. The velocity of the scoring wheel 300 and the velocity of the support wheel 500 may be equal to each other. That is, based on a horizontal line (HL of FIG. 4A) of the glass ribbon GR, the scoring wheel 300 and the support wheel 500 may move respectively along the first rail 200 and the second rail 400 to be symmetrical with each other.

While the scoring wheel 300 and the support wheel 500 are moved in the direction inclined with respect to the moving direction of the glass ribbon GR, the glass ribbon GR moves in the vertical direction, and then, the score line may be formed in the direction parallel to the Y-axis. That is, while the scoring wheel 300 is moved along the first rail 200, the glass ribbon GR is moved in the Z-axis direction, and the score line formed by the scoring wheel 300 may be formed in the direction parallel to the Y-axis.

The scoring apparatus 1000 may form the score line in the direction parallel to the width direction of the glass ribbon GR by adjusting the velocity of the scoring wheel 300. Alternatively, the scoring apparatus 1000 may form the score line in the direction parallel to the width direction of the glass ribbon GR by adjusting an inclined angle of the first rail 200.

A relation between the velocity and the angle may be expressed as Vs=Vg/Sin(θ). Here, Vs may denote a velocity of the scoring wheel, Vg may denote a velocity of the glass ribbon, and θ may denote an inclined angle of the first rail with respect to the Y-axis.

The supporter 600 of the scoring apparatus 1000 may be located below the second rail 400. That is, the supporter 600 may be located lower than the second rail 400 in the Z-axis direction. In other words, the supporter 600 may be located below the first rail 200 that is extended in parallel to the second rail 400. The supporter 600 may extend in the width direction of the glass ribbon GR. That is, the supporter 600 may extend in the Y-axis direction.

In some embodiments, the supporter 600 may be located facing the second surface GR2 of the glass ribbon GR. That is, the supporter 600 may be located above the second surface GR2.

The supporter 600 may reciprocate in the vertical direction. In other words, the supporter 600 may reciprocate in the vertical direction along the supporter frame 130 that extends in the Z-axis direction. That is, the supporter 600 may reciprocate in the direction in which the glass ribbon GR moves. The supporter 600 may provide the glass ribbon GR with the reaction force while cutting the glass ribbon GR. FIG. 1 shows the supporter 600 moving along the supporter frame 130, but one or more embodiments are not limited thereto, and the supporter 600 may vertically move along the frame 110 without using the separate supporter frame 130.

The supporter 600 may include an anvil 610 and a supporting pad 620.

The anvil 610 may reciprocate along the frame 110 or the supporter frame 130. In some embodiments, the anvil 610 may move at the same velocity as that of the glass ribbon GR. In some embodiments, the anvil 610 moves the supporting pad 620 toward the glass ribbon GR so that the supporting pad 620 comes into contact with the glass ribbon GR. In other words, the anvil 610 may move the supporting pad 620 in the X-axis direction while vertically moving along the frame 110 or the supporter frame 130.

The supporting pad 620 may come into contact with the glass ribbon GR. The supporting pad 620 may be in surface-contact with the glass ribbon GR. That is, the supporting pad 620 may be extended in the width direction of the glass ribbon GR. The supporting pad 620 may move along with the anvil 610, as the anvil 610 moves. That is, the supporting pad 620 may be attached to the anvil 610 and moved along with the anvil 610.

FIGS. 4A to 4C are plan views showing that the scoring wheel and the support wheel of the scoring apparatus according to an embodiment of the present disclosure move.

In detail, FIGS. 4A to 4C show processes in which the tip 320 and the roll pad 520 come into contact with the glass ribbon GR for forming the score line SL.

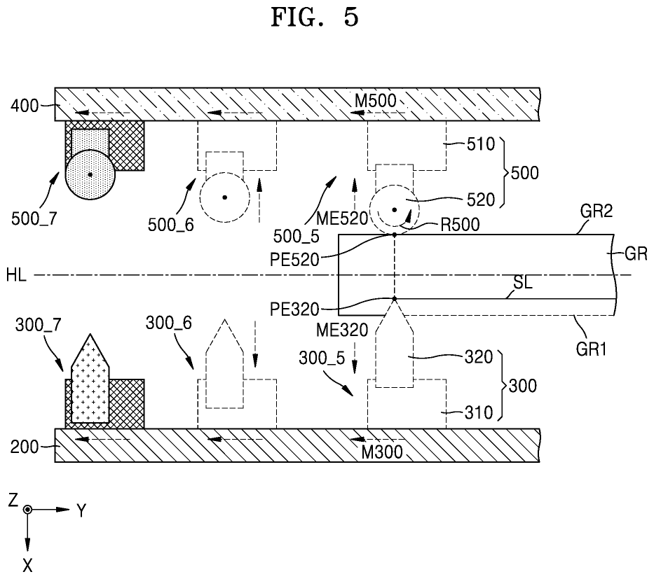

Hereinafter, referring to FIGS. 4A, 4B, 4C, and 5, the method of turning the tip 320 and the roll pad 520 respectively by the first pivot 310 and the second pivot 510 will be described below in detail.

A start point of the score line SL may include a first start point PS320 located on the first surface GR1 and a second start point PS520 located on the second surface GR2.

The scoring wheel 300 may move along the first rail 200 (M300). Simultaneously with the moving of the scoring wheel 300 along the first rail 200, the first pivot 310 may move the tip 320 toward the first surface GR1 of the glass ribbon GR.

The first pivot 310 may move the tip 320 so that the tip 320 may penetrate the glass ribbon GR to at least a part. That is, the tip 320 may be moved so as to come into contact with the first surface GR1 of the glass ribbon GR at the first start point PS320 of the score line SL, which is located on the first surface GR1 of the glass ribbon GR.

In other words, when the scoring apparatus is seen on a plane, the tip 320 may approach the glass ribbon GR while drawing a curve. After the tip 320 contacts the glass ribbon GR, the first pivot 310 fixes the tip 320 so that the score line SL of a constant depth may be formed.

In some embodiments, the first pivot 310 may move the tip 320 before the scoring wheel 300 reaches the first start point PS320 of the score line SL. That is, the first pivot 310 may move the tip 320 outside the score line SL. In other words, as the scoring wheel 300 is closer to the first start point PS320 of the score line SL, the tip 320 may be closer to the first surface GR1 of the glass ribbon GR.

The support wheel 500 may move along the second rail 400. Simultaneously with the moving of the support wheel 500 along the second rail 400, the second pivot 510 may move the roll pad 520 toward the second surface GR2 of the glass ribbon GR.

The support wheel 500 may move along the second rail 400 to be symmetrical with the scoring wheel 300 based on the glass ribbon GR (M500). In detail, the support wheel 500 may be symmetrical with the scoring wheel 300 based on the horizontal line HL crossing the glass ribbon GR. That is, the inclination angles of the first rail 200 and the second rail 400 may be the same, and the velocity of the support wheel 500 may be equal to that of the scoring wheel 300. In other words, when the scoring apparatus is seen on a plane, the support wheel 500 may move so that the support wheel 500 and the scoring wheel 300 face each other based on the glass ribbon GR.

The second pivot 510 may move the roll pad 520 so that the roll pad 520 may come into contact with the glass ribbon GR at the second start point PS520 of the score line SL. That is, at the second start point PS520 facing the first start point PS320 of the score line SL, the second pivot 510 may move the roll pad 520 so that the roll pad 520 may come into contact with the second surface GR2 of the glass ribbon GR.

The second pivot 510 may move the roll pad 520 so that the roll pad 520 is symmetrical with the tip 320 based on the glass ribbon GR. That is, the second pivot 510 may move the roll pad 520 so that an end of the roll pad 520 is symmetrical with an end of the tip 320 based on the glass ribbon GR. In other words, the second pivot 510 may move the roll pad 520 so that the roll pad 520 and the tip 320 may be symmetrical with each other based on the horizontal line HL crossing the glass ribbon GR.

In detail, a separation distance between the roll pad 520 and the second surface GR2 of the glass ribbon GR in the X-axis direction may be a first distance, and a separation distance between the tip 320 and the first surface GR1 of the glass ribbon GR in the X-axis direction may be a second distance. Here, the second pivot 510 may move the roll pad 520 so that the first distance may be equal to the second distance.

The roll pad 520 may be in a point-contact with the second surface GR2 of the glass ribbon GR. The roll pad 520 may be in a point-contact with the glass ribbon GR at the second start point PS520. In some embodiments, while the support wheel 500 moves along the score line SL, the roll pad 520 may come into a point-contact with the glass ribbon GR while rotating (R500).

The tip 320 and the roll pad 520 may be moved toward the glass ribbon GR respectively by the first pivot 310 and the second pivot 510, from the state of being spaced apart from the glass ribbon GR. The tip 320 and the roll pad 520 may initially come into contact with the glass ribbon GR at the start point of the score line SL while moving toward the glass ribbon GR.

In detail, at the start point of the score line SL, the tip 320 may come into contact with the first surface GR1 of the glass ribbon GR at the first start point PS320, and the roll pad 520 may come into contact with the second surface GR2 of the glass ribbon GR at the second start point PS520. Here, in order to improve the quality of the score line SL, the tip 320 and the roll pad 520 may be at the uniform velocity.

In some embodiments, the first pivot 310 may move the tip 320 in the X-axis direction (MS320). That is, the first pivot 310 may fix the tip 320 in the Y-axis direction and may move the tip 320 only in the X-axis direction. The second pivot 510 may move the roll pad 520 in the X-axis direction (MS520). That is, the second pivot 510 may fix the roll pad 520 in the Y-axis direction and may move the roll pad 520 only in the X-axis direction.

As shown in FIG. 4A, in a first state 300_1 in which the scoring wheel 300 starts to move along the first rail 200, the first rail 200 may move the tip 320 in the X-axis direction (MS320). In a first state 500_1 in which the support wheel 500 starts to move along the second rail 400, the second pivot 510 may move the roll pad 520 in the X-axis direction (MS520).

After that, in a second state 300_2 in which the velocity of the scoring wheel 300 moving along the first rail 200 increases, the first rail 200 may continuously move the tip 320 in the X-axis direction (MS320). In a second state 500_2 in which the velocity of the support wheel 500 moving along the second rail 400 increases, the second pivot 510 may move the roll pad 520 continuously in the X-axis direction (MS520).

After that, in a third state 300_3 in which the scoring wheel 300 passes above the start point of the score line SL, the first pivot 310 may continuously move the tip 320 so that the tip 320 may be located at the first start point PS320 of the score line SL. In a third state 500_3 in which the support wheel 500 passes above the start point of the score line SL, the second pivot 510 may continuously move the roll pad 520 so that the roll pad 520 may be located at the second start point PS520 of the score line SL.

After that, in a fourth state 300_4 in which the scoring wheel 300 forms the score line SL and is moved along the first rail 200, the first pivot 310 fixes the tip 320 to form the score line SL having consistent depth. In a fourth state 500_4 in which the support wheel 500 moves along the second rail 400, the second pivot 510 makes the roll pad 520 come into contact with the glass ribbon GR and may supply the glass ribbon GR with a constant reaction force.

In some embodiments, a first pivot 310a may move the tip 320 in the X-axis direction and the Y-axis direction (MS320a). That is, the first pivot 310a may move the tip 320 in the Y-axis direction while moving the tip 320 in the X-axis direction. A second pivot 510a may move the roll pad 520 in the X-axis direction and the Y-axis direction (MS520a). That is, the second pivot 510a may move the roll pad 520 in the Y-axis direction while moving the roll pad 520 in the X-axis direction.

As shown in FIG. 4B, in a first state 300a_1 in which a scoring wheel 300a starts to move along the first rail 200, the first pivot 310a may move the tip 320 in the X-axis direction and the Y-axis direction (MS320a). In the first state 500a_1 in which a support wheel 500a starts to move along the second rail 400, the second pivot 510a may move the roll pad 520 in the X-axis direction and the Y-axis direction (MS520a).

After that, in a second state 300a_2 in which the velocity of the scoring wheel 300a moving along the first rail 200 increases, the first pivot 310a may continuously move the tip 320 in the X-axis direction and the Y-axis direction (MS320a). In a second state 500a_2 in which the velocity of the support wheel 500a moving along the second rail 400 increases, the second pivot 510a may move the roll pad 520 continuously in the X-axis direction and the Y-axis direction (MS520a).

After that, in a third state 300a_3 in which the scoring wheel 300a passes above the start point of the score line SL, the first pivot 310a may continuously move the tip 320 so that the tip 320 may be located at the first start point PS320 of the score line SL. In a third state 500a_3 in which the support wheel 500a passes above the start point of the score line SL, the second pivot 510a may continuously move the roll pad 520 so that the roll pad 520 may be located at the second start point PS520 of the score line SL.

After that, in a fourth state 300a_4 in which the scoring wheel 300a forms the score line SL and is moved along the first rail 200, the first pivot 310a fixes the tip 320 to form the score line SL having consistent depth. In a fourth state 500a_4 in which the support wheel 500a moves along the second rail 400, the second pivot 510a makes the roll pad 520 come into contact with the glass ribbon GR and may supply the glass ribbon GR with a constant reaction force.

In some embodiments, a first pivot 310b may turn the tip 320 toward the glass ribbon GR (R321). That is, the first pivot 310b may rotate the tip 320 about the first rotary shaft 321. A second pivot 510b may turn the roll pad 520 toward the glass ribbon GR (R521). That is, the second pivot 510b may rotate the roll pad 520 about the second rotary shaft 521.

As shown in FIG. 4C, in a first state 300b_1 in which a scoring wheel 300b starts to move along the first rail 200, the first pivot 310b may turn the tip toward the glass ribbon (R321). In a first state 500b_1 in which a support wheel 500b starts to move along the second rail 400, the second pivot 510b may turn the roll pad 520 toward the glass ribbon (R521).

After that, in a second state 300b_2 in which the velocity of the scoring wheel 300b moving along the first rail 200 increases, the first pivot 310b may continuously rotate the tip 320 while maintaining the rotating direction. In a second state 500b_2 in which the velocity of the support wheel 500b moving along the second rail 400, the second pivot 510b may continuously rotate the roll pad 520 while maintaining the rotating direction.

After that, in a third state 300b_3 in which the scoring wheel 300b passes above the start point of the score line SL, the first pivot 310b may rotate the tip 320 so that the tip 320 may be located at the first start point PS320 of the score line SL. In a third state 500b_3 in which the support wheel 500b passes above the start point of the score line SL, the second pivot 510b may rotate the roll pad 520 so that the roll pad 520 may be located at the second start point PS520 of the score line SL.

After that, in a fourth state 300b_4 in which the scoring wheel 300b forms the score line SL and is moved along the first rail 200, the first pivot 310b fixes the tip 320 to form the score line SL having consistent depth. In a fourth state 500b_4 in which the support wheel 500b moves along the second rail 400, the second pivot 510b makes the roll pad 520 come into contact with the glass ribbon GR and may supply the glass ribbon GR with a constant reaction force.

FIG. 5 is a plan view showing that a score wheel and a support wheel of a scoring apparatus according to an embodiment of the present disclosure move.

In detail, FIG. 5 shows a process in which the tip 320 and the roll pad 520 are spaced apart from the glass ribbon GR after forming the score line SL.

An ending point of the score line SL may include a first ending point PE320 located on the first surface GR1 and a second ending point PE520 located on the second surface GR2.

The scoring wheel 300 may move along the first rail 200 (M300). After the scoring wheel 300 forms the score line SL while moving along the first rail 200, the first pivot 310 may isolate the tip 320 from the first surface GR1 of the glass ribbon GR.

That is, the tip 320 may be moved so as to be separated from the first surface GR1 of the glass ribbon GR at the first ending point PE320 of the score line SL, which is located on the first surface GR1 of the glass ribbon GR. In other words, when the scoring apparatus is seen on a plane, the tip 320 may be isolated from the glass ribbon GR while drawing a curve.

The support wheel 500 may move along the second rail 400. After the support wheel 500 forms the score line SL by moving along the second rail 400, the second pivot 510 may separate the roll pad 520 from the second surface GR2 of the glass ribbon GR.

The second pivot 510 may move the roll pad 520 so that the roll pad 520 may be separated from the glass ribbon GR at the second ending point PE520 of the score line SL. That is, at the second ending point PE520 facing the first ending point PE320 of the score line SL, the second pivot 510 may move the roll pad 520 to be separated from the second surface GR2 of the glass ribbon GR.

That is, at the ending point of the score line SL, the first pivot 310 may move the tip 320 so that the tip 320 is separated from the first surface GR1 of the glass ribbon GR, and the second pivot 510 may move the roll pad 520 so that the roll pad 520 is separated from the second surface GR2 of the glass ribbon GR. In other words, after forming the score line SL, the separation distance between the tip 320 and the glass ribbon GR in the X-axis direction may increase while the scoring wheel 300 moves along the first rail 200. Moreover, after forming the score line SL, the separation distance between the roll pad 520 and the glass ribbon GR in the X-axis direction may increase while the support wheel 500 moves along the second rail 400.

In some embodiments, the first pivot 310 may move the tip 320 in the X-axis direction so that the tip 320 and the glass ribbon GR may be separated from each other (ME320). That is, the first pivot 310 may fix the tip 320 in the Y-axis direction and may move the tip 320 only in the X-axis direction. The second pivot 510 may move the roll pad 520 in the X-axis direction so that the roll pad 520 and the glass ribbon GR may be separated from each other (ME520). That is, the second pivot 510 may fix the roll pad 520 in the Y-axis direction and may move the roll pad 520 only in the X-axis direction.

As shown in FIG. 5, in a fifth state 300_5 in which the scoring wheel 300 is forming the score line SL while moving along the first rail 200, the first pivot 310 may move the tip 320 in the X-axis direction so that the tip 320 is separated from the glass ribbon GR (ME320). In a fifth state 500_5 in which the support wheel 500 is forming the score line SL while moving along the second rail 400, the second pivot 510 may move the roll pad 520 in the X-axis direction so that the roll pad 520 is separated from the glass ribbon GR (ME520). Points where the tip 320 and the roll pad 520 are separated from the glass ribbon GR may be respectively at the first ending point PE320 and the second ending point PE520.

After that, in a sixth state 300_2 in which the velocity of the scoring wheel 300 along the first rail 200 is gradually decreased, the first pivot 310 may continuously move the tip 320 in the X-axis direction (ME320). In a sixth state 500_2 in which the velocity of the support wheel 500 moving along the second rail 400 is gradually decreased, the second pivot 510 may move the roll pad 520 continuously in the X-axis direction (ME520).

After that, in a seventh state 300_7 in which the scoring wheel 300 is stopped, the first pivot 310 fixes the tip 320 so that the tip 320 and the glass ribbon GR may be completely isolated from each other. In a seventh state 500_7 in which the support wheel 500 is stopped, the second pivot 510 fixes the roll pad 520 so that the roll pad 520 and the glass ribbon GR may be completely isolated from each other.

Although not shown in the drawings, the scoring wheel 300 and the support wheel 500 may return to initial positions before the forming of the score line SL, while the tip 320 and the roll pad 520 are isolated from the glass ribbon.

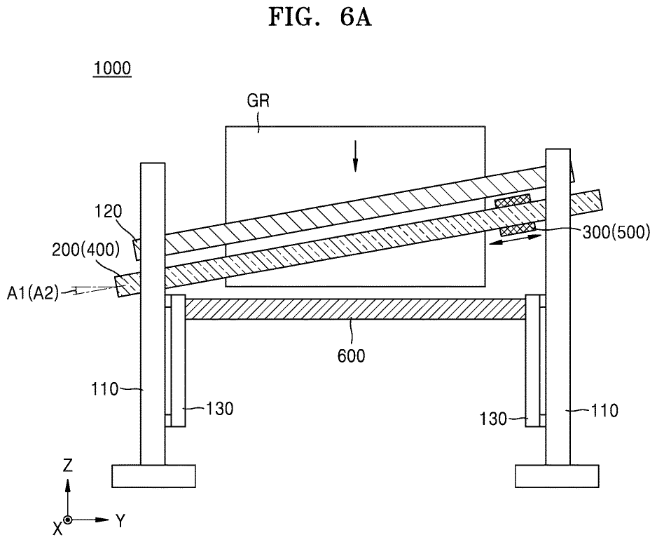

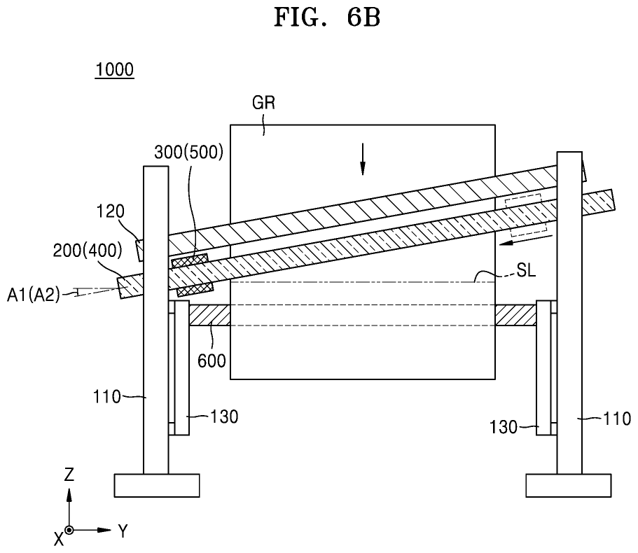

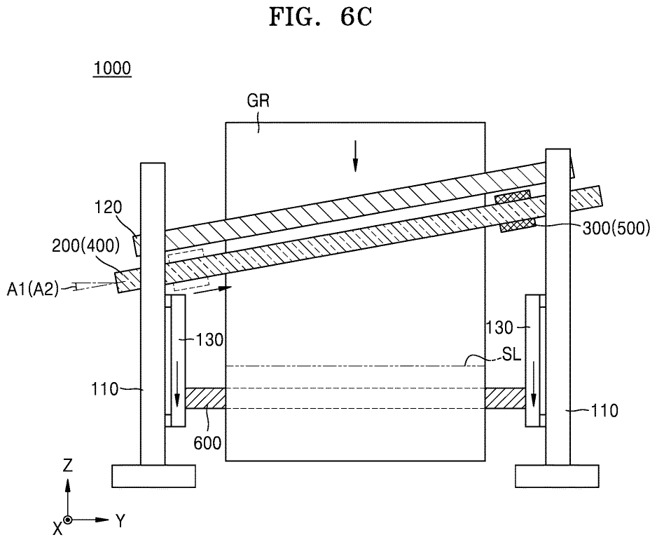

FIGS. 6A to 6C are front views sequentially showing processes of forming a score line by the scoring apparatus according to an embodiment of the present disclosure.

Referring to FIGS. 6A to 6C, aspects of driving the scoring wheel 300, the support wheel 500, and the supporter 600 of the scoring apparatus 1000 will be described in detail below.

FIG. 6A shows that the glass ribbon GR moves in the vertical direction. Here, the frames 110 may be installed on a ceiling or a ground of a working space. The glass ribbon GR may move at a consistent velocity in the vertical direction. A width of the glass ribbon GR may be greater than a thickness of the glass ribbon GR.

FIG. 6B shows that the score line SL is formed on the glass ribbon GR. The scoring wheel 300 and the support wheel 500 may simultaneously form the score line SL across the glass ribbon GR. Here, the supporter 600 may not move.

FIG. 6C shows that the glass ribbon GR on which the score line SL is formed is moved vertically. Here, the supporter 600 may move vertically according to the movement of the glass ribbon GR. In other words, the supporter 600 may move vertically while contacting the glass ribbon GR, by tracking the movement of the glass ribbon GR.

While the supporter 600 vertically moves, the scoring wheel 300 and the support wheel 500 may not vertically move. That is, the first rail 200 and the second rail 400 on which the scoring wheel 300 and the support wheel 500 are respectively located may not move in the vertical direction.

While the supporter 600 vertically moves along contacting the glass ribbon GR, the scoring wheel 300 and the support wheel 500 may return to initial positions. In other words, the scoring wheel 300 and the supporter 600 move individually, and the support wheel 500 and the supporter 600 may move individually.

That is, independently from the movement of the supporter 600, the scoring wheel 300 and the support wheel 500 may prepare for forming new score line SL. In other words, while the supporter 600 moves downward while supporting the glass ribbon GR, the scoring wheel 300 and the support wheel 500 may return to the initial positions.

Moreover, during forming the score line SL by the scoring wheel 300 and the support wheel 500, the supporter 600 may prepare for supporting the glass ribbon GR. In other words, while the scoring wheel 300 and the support wheel 500 crosses the glass ribbon GR while forming the score line SL, the supporter 600 may move upward.

In some embodiments, the supporter 600 may come into contact with the glass ribbon GR under the score line SL. That is, the supporter 600 may come into contact with the second surface of the glass ribbon GR under the score line SL in the vertical direction. During a process of bending the glass ribbon GR, the supporter 600 supports the glass ribbon GR, and thus, the supporter 600 may come into contact with the glass ribbon GR under the score line SL so that the glass ribbon GR may be cut along the score line SL. However, one or more embodiments are not limited thereto, and the supporter 600 may come into contact with the glass ribbon GR at the score line SL.

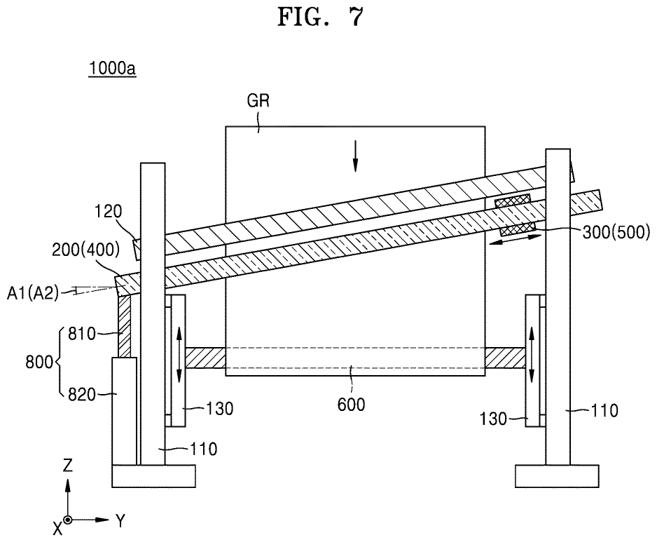

FIG. 7 is a front view schematically showing a scoring apparatus according to an embodiment of the present disclosure.

Referring to FIG. 7, a scoring apparatus 1000a may include the frames 110, the guide 120, the first rail 200, the second rail 400, the scoring wheel 300, the support wheel 500, the supporter 600, and an angle adjuster 800.

Hereinafter, descriptions about the elements of the scoring apparatus 1000a of FIG. 7 as those of the scoring apparatus 1000 of FIG. 1 will be omitted, and differences will be described below.

The scoring apparatus 1000a may further include the angle adjuster 800. The angle adjuster 800 may adjust angles of the first rail 200 and the second rail 400. That is, the angle adjuster 800 may adjust the first angle A1 and the second angle A2. In detail, the angle adjuster 800 may adjust the inclined degrees of the first rail 200 and the second rail 400 with respect to the moving direction of the glass ribbon GR. In some embodiments, the angle adjuster 800 may operate via hydraulic pressure.

In some embodiments, the angle adjuster 800 may include a first actuator 820 and a piston 810. The piston 810 may be connected to the first rail 200 and the second rail 400 via one end thereof, and may be connected to the first actuator 820 via the other end. The piston 810 may be moved up and down by the first actuator 820. While the piston 810 is moved up and down, the inclined angles of the first rail 200 and the second rail 400 may be changed. In detail, when the first actuator 820 moves the piston 810 upward, the first angle A1 and the second angle A2 may be reduced. When the first actuator 820 moved the piston 810 downward, the first angle A1 and the second angle A2 may be increased.

According to the production environment such as the velocity of the glass ribbon GR, the velocity of the scoring wheel 300, etc., the angle adjuster 800 may adjust the inclined angles of the first rail 200 and the second rail 400.

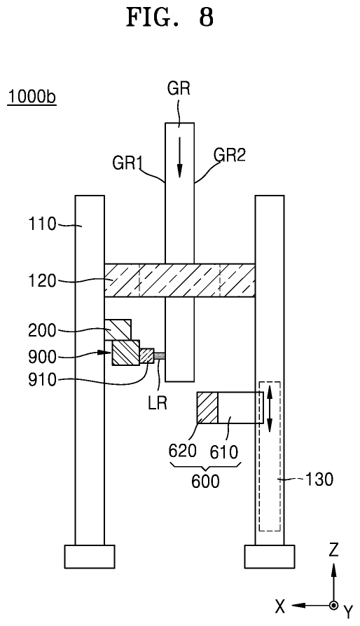

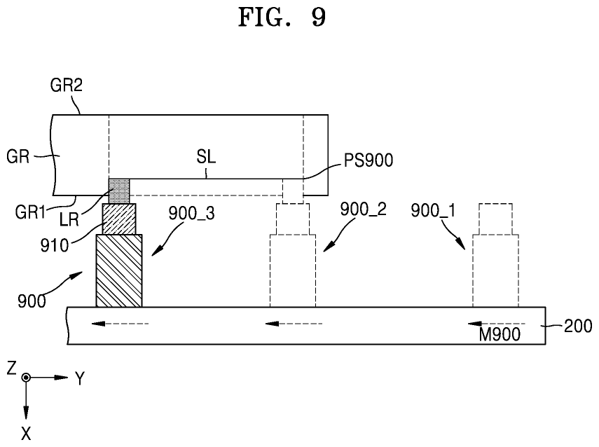

FIG. 8 is a side view schematically showing a scoring apparatus according to an embodiment of the present disclosure. FIG. 9 is a plan view showing that the scoring apparatus of FIG. 8 forms a score line.

Referring to FIGS. 8 and 9, a scoring apparatus 1000b may include the frames 110, the guide 120, the first rail 200, a scoring wheel 900, and the supporter 600.

Hereinafter, descriptions about the elements of the scoring apparatus 1000b of FIG. 8 as those of the scoring apparatus 1000 of FIG. 1 will be omitted, and differences will be described below.

The scoring apparatus 1000b may include the scoring wheel 900 reciprocating along the first rail 200. The scoring wheel 900 may form the score line SL on the first surface GR1 of the glass ribbon GR.

The scoring wheel 900 may include a laser device 910. The scoring wheel 900 may form the score line SL without contacting the glass ribbon GR, by using the laser device 910.

The laser device 910 of the scoring wheel 900 may irradiate laser LR toward the first surface GR1 of the glass ribbon GR. The laser LR generates heat on the first surface GR1 of the glass ribbon GR to form the score line SL. The depth of the score line SL may be adjusted by adjusting an intensity of the laser LR.

In some embodiments, the scoring apparatus 1000b may include a cooling device (not shown). The cooling device may face the second surface GR2 of the glass ribbon GR. The cooling device may cool down the glass ribbon GR on the second surface GR2 of the glass ribbon GR, when the first surface GR1 of the glass ribbon GR is heated by the laser device 910. Quality of the score line SL may be improved via the cooling device.

As shown in FIG. 9, in a first state 900_1 in which the scoring wheel 900 starts to move along the first rail 200, the laser device 910 is fixed to the scoring wheel 900 and is isolated from the glass ribbon GR.

After that, in a second state 900_2 in which the scoring wheel 900 reaches a start point PS900 of the score line SL, the laser device 910 may irradiate the laser LR. Here, the separation distance between the laser device 910 and the glass ribbon GR may be consistent. That is, the laser device 910 may be isolated from the glass ribbon GR and may irradiate the laser to the start point PS900 of the score line SL.

After that, in a third state 900_3 in which the scoring wheel 900 is moved along the first rail 200 while forming the score line SL, the laser device 910 may continuously irradiate the laser LR onto the first surface GR1. That is, the laser device 910 may irradiate the laser LR to the first surface GR1 while constantly maintaining the intensity of the laser LR. The laser device 910 may form the score line SL of a consistent depth by irradiating the laser LR of consistent intensity to the first surface.

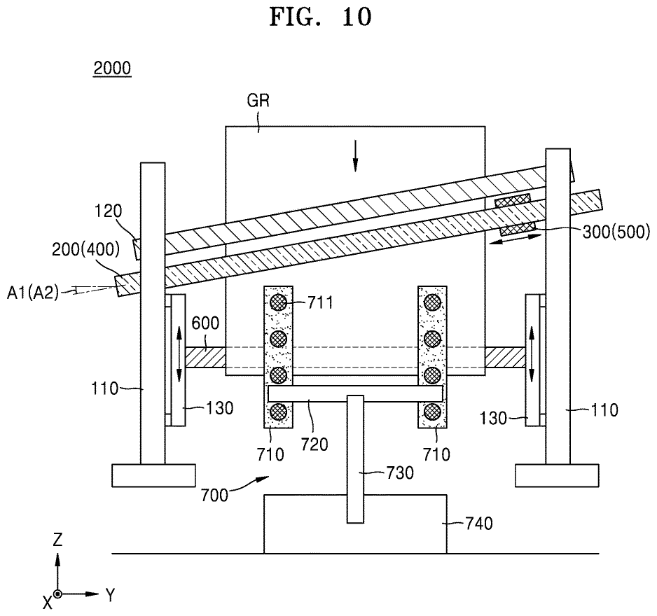

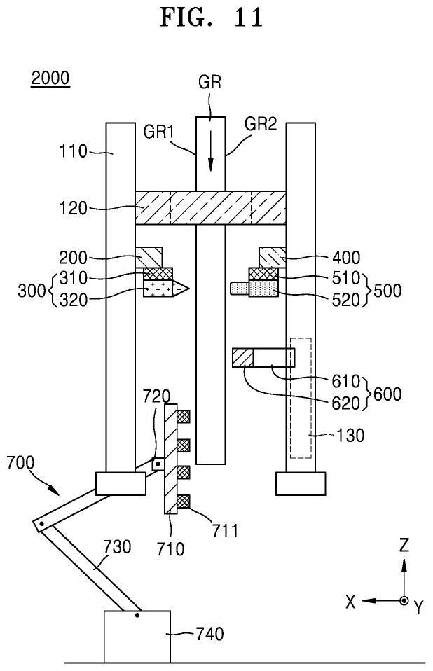

FIG. 10 is a front view schematically showing a glass cutting apparatus according to an embodiment of the present disclosure. FIG. 11 is a side view schematically showing a glass cutting apparatus according to an embodiment of the present disclosure.

Referring to FIGS. 10 and 11, the glass cutting apparatus 2000 may include the frames 110, the guide 120, the first rail 200, the second rail 400, the scoring wheel 300, the support wheel 500, the supporter 600, and a bender 700.

Hereinafter, descriptions about redundant elements of the glass cutting apparatus of FIG. 10 and the scoring apparatus of FIG. 1 are omitted, and differences will be described below.

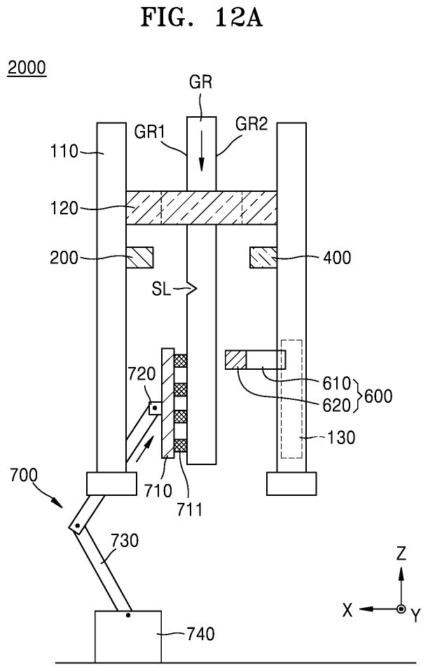

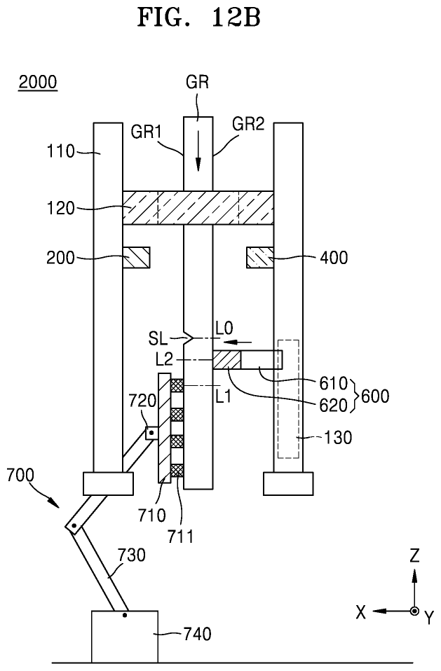

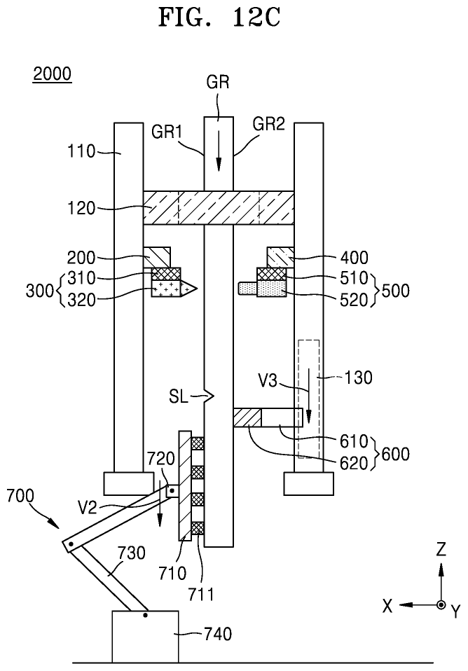

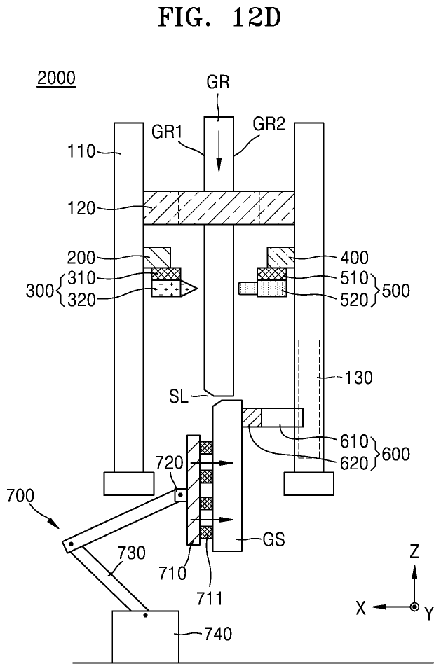

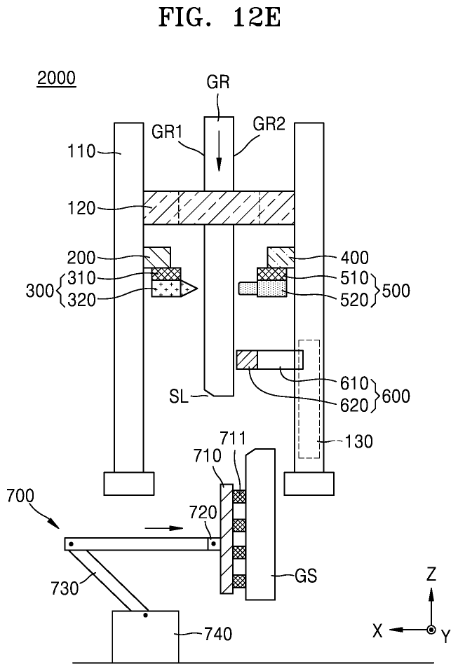

The glass cutting apparatus 200 may cut the glass ribbon GR that moves vertically. In detail, the glass cutting apparatus 2000 may form a glass sheet by forming a score line SL (see FIG. 12A) on the glass ribbon GR moving vertically and bending the glass ribbon GR. A surface of the glass ribbon GR on which the score line is generated is referred to as the first surface GR1.

The frame 110, the guide 120, the first rail 200, the second rail 400, the scoring wheel 300, the support wheel 500, and the supporter 600 of the glass cutting apparatus 2000 may be respectively the frame 110 (see FIG. 1), the guide 120 (see FIG. 1), the first rail 200 (see FIG. 1), the second rail 400 (see FIG. 1), the scoring wheel 300 (see FIG. 1), the support wheel 500 (see FIG. 1), and the supporter 600 (see FIG. 1) described above.

While the scoring wheel 300 and the support wheel 500 are moved in the direction inclined with respect to the moving direction of the glass ribbon GR, the glass ribbon GR moves in the vertical direction, and then, the score line may be formed in the direction parallel to the Y-axis. That is, while the scoring wheel 300 is moved along the first rail 200, the glass ribbon GR is moved in the Z-axis direction, and the score line formed by the scoring wheel 300 may be formed in the direction parallel to the Y-axis.

The bender 700 of the glass cutting apparatus may be located at the lower portion of the first rail. That is, the bender 700 may be located below the first rail 200. The bender 700 may reciprocate in the vertical direction. That is, the bender 700 may be moved in the Z-axis direction below the first rail 200 in the vertical direction.

The bender 700 may come into contact with the glass ribbon GR. The bender 700 may come into contact with the first surface GR1 or the second surface GR2 of the glass ribbon GR. That is, the bender 700 may move in the X-axis direction and comes into contact with the first surface GR1 or the second surface GR2 of the glass ribbon GR.

Here, a contact location between the bender 700 and the glass ribbon GR may be under the score line SL (see FIG. 4A). That is, the bender 700 may come into contact with the glass ribbon GR at the lower position than the score line.

The bender 700 may bend the glass ribbon GR in the X-axis direction. In other words, the bender 700 may bend the glass ribbon GR in the direction perpendicular to the moving direction of the glass ribbon GR. That is, the bender 700 may exert the force to the glass ribbon GR in the X-axis direction. For example, the bender 700 may exert the force on the glass ribbon GR by continuously moving in the X-axis direction after contacting the glass ribbon.

Here, the position where the bender 700 bends the glass ribbon GR may be lower than the score line SL (see FIG. 4A). That is, the bender 700 may exert the force on the glass ribbon GR in the X-axis direction below the score line.

In some embodiments, the bender 700 may be located separating from the first surface GR1 of the glass ribbon GR, and the bender 700 may move in the X-axis direction to come into contact with the first surface GR1 of the glass ribbon GR. In other words, the bender 700 may move toward the glass ribbon GR in the X-axis direction and come into contact with the first surface GR1 of the glass ribbon GR.

In some embodiments, the bender 700 may come into contact with the first surface GR1 of the glass ribbon GR, and may exert the force on the glass ribbon GR in the direction from the first surface GR1 toward the second surface GR2. That is, the bender 700 may continuously move toward the first surface GR1 of the glass ribbon GR in the X-axis direction to come into contact with the first surface GR1 of the glass ribbon GR, and bend the glass ribbon GR in the direction from the first surface GR1 toward the second surface GR2.

In some embodiments, the bender 700 may be located separating from the second surface GR2 of the glass ribbon GR, and the bender 700 may move in the X-axis direction to come into contact with the second surface GR2 of the glass ribbon GR. In other words, the bender 700 may move toward the glass ribbon GR in the X-axis direction and come into contact with the second surface GR2 of the glass ribbon GR.

Here, the bender 700 and the supporter 600 may be spaced apart from each other with the glass ribbon GR interposed therebetween. In other words, the bender 700 may be located on the upper portion of the first surface GR1 of the glass ribbon GR, and the supporter 600 may be located on the upper portion of the second surface GR2 of the glass ribbon GR. When the bender 700 pushes the first surface GR1 of the glass ribbon GR, the supporter 600 may support the glass ribbon GR from the second surface GR2 of the glass ribbon GR.

In some embodiments, the bender 700 may come into contact with the second surface GR2 of the glass ribbon GR, and may exert the force on the glass ribbon GR in the direction from the first surface GR1 toward the second surface GR2. That is, the bender 700 may generate a negative pressure between the bender 700 and the glass ribbon GR, and may bend the glass ribbon GR in a direction from the first surface GR1 toward the second surface GR2. In other words, the bender 700 may move in the direction from the first surface GR1 toward the second surface GR2 while absorbing the second surface GR2 of the glass ribbon GR, and thus, the glass ribbon GR may be bent.

Here, the bender 700 and the supporter 600 may face the second surface of the glass ribbon GR. In other words, the bender 700 and the supporter may be located on the upper portion of the second surface GR2 of the glass ribbon GR. When the bender 700 pulls the second surface GR2 of the glass ribbon GR, the supporter 600 may support the glass ribbon GR from the second surface GR2 of the glass ribbon GR.

When the glass ribbon GR with the score line SL (see FIG. 12A) formed thereon is bent, the glass ribbon GR may be cut along the score line SL. A part of the glass ribbon GR, which is weakened by the score line SL, may be easily broken due to the external force. That is, the bender 700 exerts the force on the glass ribbon GR to damage the glass ribbon GR along the score line SL. Accordingly, the glass cutting apparatus 2000 may form the score line on the glass ribbon GR, and may cut the glass ribbon GR along the score line to manufacture glass sheets.

In some embodiments, the bender 700 may include a contact frame 710, a connect frame 720, an arm 730, and an adjuster 740.

The bender 700 may include at least one contact frame 710. For examples, the bender 700 may include two or more contact frames 710 in order to increase a contact area between the bender 700 and the glass ribbon GR.

A plurality of contact frames 710 may be connected to the connect frame 720. That is, the plurality of contact frames 710 may be connected to one connect frame 720 and may be simultaneously moved.

The contact frame 710 may include a plurality of contact pads 711. The contact frame 710 may come into contact with the glass ribbon GR. In detail, the contact frame 710 may have the plurality of contact pads 711 coming into contact with the glass ribbon. The plurality of contact pads 711 may restrain the surface of the glass ribbon GR from being scratched when the glass ribbon GR and the contact frame 710 come into contact with each other.

One end of the arm 730 in the bender 700 may be connected to the connect frame 720 and the other end may be connected to the adjuster 740. One end of the arm 730 may be moved in the X-axis, Y-axis, or Z-axis direction and the other end of the arm 730 may be fixed to the adjuster 740.

The adjuster 740 of the bender 700 may adjust the arm 730 so as to move the connect frame 720. That is, the adjuster 740 may move the connect frame 720 in the X-axis, Y-axis, or Z-axis direction via the arm 730. Accordingly, the contact frame 710 connected to the connect frame 720 may be moved in the X-axis, Y-axis, or Z-axis direction.

The contact frame 710 is moved by the adjuster 740 and may exert the external force in the direction from the first surface GR1 toward the second surface GR2 of the glass ribbon GR. That is, the contact frame 710 may exert the force on the glass ribbon GR in the direction from the first surface GR1, on which the score line is formed, toward the second surface GR2 having no score line.

In some embodiments, the contact frame 710 may exert the force on the glass ribbon GR while moving in the direction from the first surface GR1 toward the second surface GR2 in a state of being in contact with the first surface GR1 of the glass ribbon GR.

In some embodiments, the adjuster 740 may generate vacuumed state between the glass ribbon GR and the plurality of contact pads 711 while the contact frame 710 is in contact with the second surface GR2 of the glass ribbon GR. While the contact frame 710 and the glass ribbon GR are sucked to each other via vacuum, the contact frame 710 may exert the force on the glass ribbon GR while moving in the direction from the first surface GR1 toward the second surface GR2.

FIGS. 12A to 12E are side views sequentially showing processes of forming a score line by the glass cutting apparatus according to an embodiment of the present disclosure.

Referring to FIGS. 12A to 12E, processes of forming the score line SL on the glass ribbon GR and cutting the glass ribbon GR along the score line SL will be described below. An example in which the bender 700 is spaced so as to face the first surface GR1 of the glass ribbon GR will be described, but one or more embodiments are not limited thereto.

FIG. 12A shows that the score line SL is formed on the glass ribbon GR and the bender 700 comes into contact with the glass ribbon GR.

The score line SL may be formed when the tip 320 and the roll pad 520 move along the first rail 200 and the second rail 400 that are inclined while contacting the glass ribbon GR. The way of the tip 320 and the roll pad 520 coming into contact with the glass ribbon GR may include the method described above with reference to FIGS. 4A to 4C.

The glass cutting apparatus 2000 may form the score line SL in a direction parallel to the Y-axis by adjusting the angle of the first rail 200, the velocity of the glass ribbon GR, and the velocity of the scoring wheel 300. That is, the first rail 200 may be inclined according to the velocity of the glass ribbon GR, and then, the score line SL may be formed parallel to the width direction of the glass ribbon GR.

After the scoring wheel 300 and the support wheel 500 form the score line SL across the glass ribbon GR, the contact frame 710 of the bender 700 may come into contact with the first surface GR1 of the glass ribbon GR. In detail, the adjuster 740 may move the contact frame 710 so that the glass ribbon GR and the contact frame 710 come into contact with each other under the score line SL of the glass ribbon GRs.

FIG. 12B shows that the supporter 600 comes into contact with the glass ribbon GR while the glass ribbon GR on which the score line SL is formed moves in the vertical direction.

The glass ribbon GR on which the score line SL is formed may be moved at a constant velocity. That is, the glass ribbon GR may vertically move at a constant velocity. The contact frame 710 may vertically move while coming into contact with the first surface GR1 of the glass ribbon GR. That is, the contact frame 710 may vertically move at the same velocity as that of the glass ribbon GR in the vertical direction. In other words, the bender 700 may move at the same velocity as that of the glass ribbon GR while tracking the movement of the glass ribbon GR.

The supporter 600 may come into contact with the second surface GR2 of the glass ribbon GR, on which the score line SL is formed. That is, the supporter 600 may be attached to the second surface GR2 of the glass ribbon GR that is moving with the bender 700 attached to the first surface thereof. In other words, the supporter 600 may move in the X-axis direction and come into contact with the second surface GR2 of the glass ribbon GR. For example, the anvil 610 of the supporter 600 moves the supporting pad 620 of the supporter 600 in the X-axis direction, so that the supporting pad 620 comes into contact with the second surface GR2 of the glass ribbon GR.

A first height L2 of a point where the supporter 600 and the second surface GR2 of the glass ribbon GR come into contact with each other may be lower than a second height L0 of the score line SL. Moreover, the first height L2 may be substantially equal to the second height L0.

In some embodiments, the first height L2 of the point where the supporter 600 and the second surface GR2 of the glass ribbon GR come into contact with each other may be higher than a third height L1 of a point where the bender 700 and the first surface GR1 of the glass ribbon GR come into contact with each other. That is, the supporter 600 may come into contact with the glass ribbon GR at a higher position than the bender 700. In other words, while the supporter 600 and the bender 700 are in contact with the glass ribbon GR, the supporter 600 may be located higher than the bender 700 and lower than the score line SL. For example, the first height L2 may be lower than the second height L0 and higher than the third height L1.

FIG. 12C shows that the supporter 600 and the bender 700 are vertically moved along the glass ribbon GR while the glass ribbon GR is moved.

The glass ribbon GR may vertically move at a constant velocity. During the processes in which the score line SL is formed and the glass ribbon GR is cut along the score line SL, the glass ribbon GR may move at a constant velocity. For example, the glass ribbon GR may vertically move at a first velocity V1 at all times, regardless of the status of the glass cutting apparatus 2000.

The supporter 600 and the bender 700 may vertically move downward along the glass ribbon GR. That is, the supporter 600 and the bender 700 may move in the same direction as the moving direction of the glass ribbon GR while contacting the glass ribbon GR.

The supporter 600 and the bender 700 contacting the glass ribbon GR may move at the same velocity as that of the glass ribbon GR. For example, a velocity of the bender 700 in the Z-axis direction is a second velocity V2 and a velocity of the supporter 600 in the Z-axis direction may be a third velocity V3. The second velocity V2 and the third velocity V3 may be equal to the first velocity V1. In some embodiments, the supporter 600 and the bender 700 track the glass ribbon GR, and may be moved so as to come into contact with the glass ribbon GR at a constant position.

In some embodiments, while the supporter 600 and the bender 700 move along the glass ribbon GR, the scoring wheel 300 and the support wheel 500 may return to the initial positions. That is, the scoring wheel 300 and the support wheel 500 may move without regard to the movement of the supporter 600. For example, the vertical movement of the anvil 610 of the supporter 600 and the reciprocating movements of the scoring wheel 300 and the support wheel 500 are independent from each other. In other words, while the supporter 600 and the bender 700 move in contact with the glass ribbon GR, the scoring wheel 300 and the support wheel 500 may prepare for forming a new score line.

FIG. 12D shows a process of cutting the glass ribbon GR along the score line SL.

The bender 700 may bend the glass ribbon GR. The bender 700 may bend the glass ribbon GR in a direction from the first surface GR1 toward the second surface GR2 of the glass ribbon GR. That is, the bender 700 may exert the force on the glass ribbon GR in the direction from the first surface GR1 toward the second surface GR2 of the glass ribbon GR.

In some embodiments, the bender 700 may exert the force on the glass ribbon GR, while the contact frame 710 moves in the direction from the first surface GR1 toward the second surface GR2 of the glass ribbon GR. Here, the supporting pad 620 of the supporter 600 may support the second surface GR2 of the glass ribbon GR. For example, when the glass ribbon GR is bent by the bender 700, a point where the supporting pad 620 contacts may function as a rotary shaft.

In some embodiments, while the contact frame 710 rotates in the direction from the first surface GR1 toward the second surface GR2, the bender 700 may exert the force on the glass ribbon GR. That is, the bender 700 generates a torque on the glass ribbon GR, the glass ribbon GR may be bent in the direction from the first surface GR1 toward the second surface GR2. Here, the supporting pad 620 supports the second surface GR2 of the glass ribbon GR to function as a rotary shaft of the glass ribbon GR.

FIG. 12E shows a process of transporting a glass sheet GS.

The glass sheet GS may denote a sheet of glass cut and separated from the glass ribbon GR along the score line SL. In some embodiments, the score line SL formed through the first rail 200 and the second rail 400 that are inclined is parallel to the Y-axis direction, and thus, the glass sheet GS may have a rectangular shape.

The bender 700 may transfer the glass sheet GS to a container (not shown) while maintaining the contact with the glass sheet GS. In some embodiments, the container is located on the upper portion of the second surface GS2 of the glass ribbon GR, and the bender 700 continuously moves in the X-axis direction after cutting the glass ribbon GR to transfer the glass sheet GS to the container.

While the bender 700 transfers the glass sheet GS, the supporter 600 may return to the initial position. In other words, the supporter 600 may vertically move without regard to the movement of the bender 700. In some embodiments, when the supporter 600 returns to the initial position, the scoring wheel 300 and the support wheel 500 may form a new score line. That is, the scoring wheel 300 and the support wheel 500 may move independently from the movement of the supporter 600.

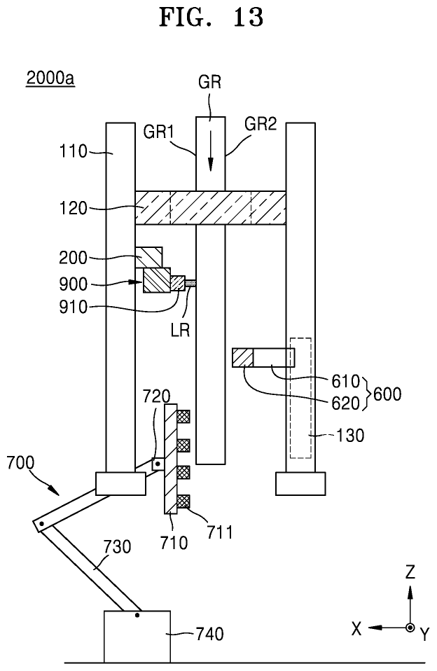

FIG. 13 is a side view schematically showing a glass cutting apparatus according to an embodiment of the present disclosure.

Referring to FIG. 13, a glass cutting apparatus 2000a may include the frame 110, the guide 120, the first rail 200, a scoring wheel 900, the supporter 600, and the bender 700.

Hereinafter, descriptions about the elements of the glass cutting apparatus 2000a of FIG. 13 as those of the glass cutting apparatus 2000 of FIG. 1 will be omitted, and differences will be described below.

In the glass cutting apparatus 2000a, the glass ribbon GR and the scoring wheel 900 may not be in contact with each other during the process of forming the score line SL. That is, the glass cutting apparatus 2000a may form the score line SL on the glass ribbon GR in a non-contact manner.

The glass cutting apparatus 2000a may include the scoring wheel 900 reciprocating along the first rail 200. The scoring wheel 900 may form the score line SL on the first surface GR1 of the glass ribbon GR.

The scoring wheel 900 may include a laser device 910. The scoring wheel 900 may form the score line SL without contacting the glass ribbon GR, by using the laser device 910.

The laser device 910 of the scoring wheel 900 may irradiate laser LR toward the first surface GR1 of the glass ribbon GR. The laser LR generates heat on the first surface GR1 of the glass ribbon GR to form the score line SL. The depth of the score line SL may be adjusted by adjusting an intensity of the laser LR.

In some embodiments, the scoring apparatus 1000b may include a cooling device (not shown). The cooling device may face the second surface GR2 of the glass ribbon GR. The cooling device may cool down the glass ribbon GR on the second surface GR2 of the glass ribbon GR, when the first surface GR1 of the glass ribbon GR is heated by the laser device 910. Quality of the score line SL may be improved via the cooling device.

In some embodiments, the glass cutting apparatus may include the scoring apparatus of FIG. 8.

The scoring apparatus according to the embodiments of the present disclosure may reduce an interval between processes of forming score lines. Accordingly, the speed of forming the glass sheet may increase, and the time taken to manufacture glass sheets may be reduced.

The glass cutting apparatus according to the present disclosure may divide the structure of cutting the glass ribbon along the score line and the structure of transporting the glass sheet, in order to improve the transport efficiency of the glass sheets.

However, effects of the present disclosure are not limited to the above disclosure. The effects of the present disclosure are not limited to the above-mentioned effects, and the unmentioned effects can be clearly understood by those skilled in the art to which the present disclosure pertains from the specification and the accompanying drawings.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A scoring apparatus for scoring a glass ribbon moving in a vertical direction, the scoring apparatus comprising:
a first rail which is spaced apart from and faces a first surface of the glass ribbon, and crosses the glass ribbon in a direction inclined with respect to the vertical direction;
a scoring wheel reciprocating along the first rail and comprising a first pivot and a tip;
a second rail that is spaced apart from a second surface while facing the second surface and extends parallel to the first rail, the second surface being opposite to the first surface of the glass ribbon;
a support wheel reciprocating along the second rail and comprising a second pivot and a roll pad; and
a supporter located below the second rail and configured to reciprocate in the vertical direction,
wherein the tip forms a score line on the first surface of the glass ribbon.

2. The scoring apparatus of claim 1, wherein, when the scoring wheel moves along the first rail,
the first pivot moves the tip to come into contact with the first surface of the glass ribbon at a start point of the score line,
and moves the tip to separate from the first surface of the glass ribbon at an ending point of the score line.

3. The scoring apparatus of claim 2, wherein the first pivot moves the tip before the scoring wheel reaches the start point.

4. The scoring apparatus of claim 2, wherein, when the support wheel moves along the second rail,
the second pivot moves the roll pad to come into contact with the second surface of the glass ribbon at a start point of the score line,
and moves the roll pad to separate from the second surface of the glass ribbon at an ending point of the score line.

5. The scoring apparatus of claim 4, wherein
the support wheel moves along the second rail to be symmetrical with the scoring wheel based on the glass ribbon, and
the second pivot moves the roll pad such that the roll pad and the tip are symmetrical with each other based on the glass ribbon.

6. The scoring apparatus of claim 1, wherein the supporter reciprocates separately from the movement of the scoring wheel and the movement of the support wheel.

7. The scoring apparatus of claim 1, wherein the supporter is located to face the second surface of the glass ribbon.

8. The scoring apparatus of claim 1, wherein the supporter comes into contact with the glass ribbon under the score line.

9. The scoring apparatus of claim 1, wherein the supporter is in a surface-contact with the glass ribbon.

10. The scoring apparatus of claim 1, further comprising an angle adjuster configured to adjust inclined angles of the first rail and the second rail.

11. A glass cutting apparatus for forming a glass sheet by cutting a glass ribbon moving in a vertical direction, the glass cutting apparatus comprising:
a first rail which is spaced apart from and faces a first surface of the glass ribbon, and crosses the glass ribbon in a direction inclined with respect to the vertical direction;
a scoring wheel reciprocating along the first rail and forming a score line on the first surface of the glass ribbon;
a supporter located below the first rail and configured to reciprocate in the vertical direction; and
a bender located below the first rail and configured to reciprocate in the vertical direction,
wherein the bender bends the glass ribbon in a direction perpendicular to the vertical direction at a position lower than the score line.

12. The glass cutting apparatus of claim 11, wherein the bender is absorbed on the first surface of the glass ribbon.

13. The glass cutting apparatus of claim 12, wherein the bender bends the glass ribbon in a direction from the first surface toward a second surface that is opposite to the first surface.

14. The glass cutting apparatus of claim 11, wherein the bender moves in the vertical direction at a velocity that is equal to a velocity of the glass ribbon.

15. The glass cutting apparatus of claim 11, wherein the supporter comes into contact with the glass ribbon above a point where the bender is in contact with the glass ribbon.

16. The glass cutting apparatus of claim 11, wherein the scoring wheel comprises a laser device that is configured to irradiate laser onto the first surface of the glass ribbon.

17. The glass cutting apparatus of claim 11, further comprising:
a second rail that is spaced apart from a second surface while facing the second surface and extends parallel to the first rail, the second surface being opposite to the first surface of the glass ribbon; and
a support wheel reciprocating along the second rail and comprising a second pivot and a roll pad,
wherein the scoring wheel comprises a first pivot and a tip.

18. The glass cutting apparatus of claim 11, wherein the bender is spaced apart from the supporter with the glass ribbon interposed therebetween.

19. A glass cutting apparatus for forming a glass sheet by cutting a glass ribbon moving in a vertical direction, the glass cutting apparatus comprising:
a first rail which is spaced apart from and faces a first surface of the glass ribbon, and crosses the glass ribbon in a direction inclined with respect to the vertical direction;
a scoring wheel reciprocating along the first rail and comprising a tip and a first pivot configured to move the tip;
a second rail that is spaced apart from a second surface while facing the second surface and extends parallel to the first rail, the second surface being opposite to the first surface of the glass ribbon;
a support wheel reciprocating along the second rail and comprising a roll pad and a second pivot configured to move the roll pad;
a supporter that is located under the second rail, is spaced apart from the second surface of the glass ribbon while facing the second surface, and is configured to reciprocate in the vertical direction; and
a bender that is located under the second rail, is spaced apart from the first surface of the glass ribbon while facing the first surface, and is configured to reciprocate in the vertical direction while tracking the glass ribbon,
wherein the tip forms a score line on the first surface of the glass ribbon,
the bender is absorbed onto the glass ribbon under the score line and bends the glass ribbon in a direction from the first surface toward the second surface, and
the supporter comes into contact with the glass ribbon above a point where the bender is in contact with the glass ribbon.

20. The glass cutting apparatus of claim 19, wherein, when the scoring wheel moves along the first rail,
the first pivot turns the tip to come into contact with the first surface of the glass ribbon at a start point of the score line, and to separate from the first surface of the glass surface at an ending point of the score line,
the support wheel moves along the second rail to be symmetrical with the scoring wheel based on the glass ribbon, and
the second pivot turns the roll pad to be symmetrical with the tip based on the glass ribbon.
